(19) United States
(12) Patent Application Publication
(10) Pub. No.: US 2013/0097235 A1
(43) Pub. Date: Apr. 18, 2013

(54) ONLINE OR OFFLINE VIRTUAL HONOR SYSTEM

(71) Applicants: Tiger T.G. Zhou, Tiburon, CA (US); Dylan T.X. Zhou, San Gabriel, CA (US); Andrew H.B. Zhou, Tiburon, CA (US)

(72) Inventors: Tiger T.G. Zhou, Tiburon, CA (US); Dylan T.X. Zhou, San Gabriel, CA (US); Andrew H.B. Zhou, Tiburon, CA (US)

(21) Appl. No.: 13/273,311

(22) Filed: Oct. 14, 2011

(51) Int. Cl. G06F 15/16

(52) U.S. Cl. 709/204

(57) ABSTRACT

Provided are novel methods and systems for selecting members of virtual governments of online communities and establishing various honor systems in the online communities. Proposed techniques may be used to stimulate certain activities of online community members and discourage other activities. A self-governance system may be established within an online community through active participation of its members. In certain embodiments, activities are associated with reward points, and members can accumulate these points based on completing one or more of these activities. Members with the most accumulated points are appointed to the virtual government of their communities and/or rewarded for their efforts. Some examples of activities include participating in social network forums, conducting product reviews, and purchasing and/or selling products. Activities may be categorized in order to identify category winners as well as overall winners. Furthermore, an online community may create various clusters for conducting such elections and contests.

### FIELD

This application relates generally to data processing, and more specifically to systems and methods for selecting one or more members of a virtual government of an online community.

### BACKGROUND

Online communities, social networking, and other forms of online group communications have recently exploded in popularity. Governance in such groups is usually provided by corporate entities/service providers that technically support these venues, i.e., provide hardware and software resources to allow such groups to exist and function. A few examples of service providers include Second Life, Badoo, Bebo, Cyworld, Facebook, FriendFeed, Friendster, Google+, Hi5, ibibo, Jaiku, Myspace, Netlog, Orkut, StudiVZ, Tagged, Tribe.net, Tuenti, Twitter, Vkontakte, Whispurr, Hub Culture, LinkedIn, Plaxo, Viadeo, XING, among many others.

A service provider may implement an age restriction, language restriction, content restriction, and geographical location restriction, just to name a few examples. These externally imposed restrictions often interfere with naturally developing relationships and communication among online community members. For example, these restrictions may be imposed because of specific business interest of the corporate entity.

Methods for self-governance are generally not provided within online communities. As a result, online communities often have limited utility to their users and limited to a few activities, such as sharing short messages about their daily life, posting photos, writing blogs on various points of interest, and alike. User experience of online communities can be greatly enriched if various self-governance tools are provided to its members.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are novel methods and systems for selecting members of virtual governments of online communities and establishing various honor systems in the online communities. The selection can be performed via an online voting system. Proposed techniques may be used to stimulate certain activities of online community members and discourage other activities. A self-control system may be established within an online community through active participation of its members. In certain embodiments, activities are associated with reward points, and members can accumulate these points based on completing one or more of these activities. Members with the most accumulated points are appointed to the virtual government of their communities and/or rewarded for their efforts. Some examples of activities include participating in social network forums, conducting product reviews, and purchasing and/or selling products. Activities may be categorized in order to identify category winners as well as overall winners. Furthermore, an online community may create various clusters for conducting such elections and contests.

In certain embodiments, a computer-implemented method for selecting one or more members of a virtual government of an online community is provided. This method may involve setting a list of rewardable activities, such that each rewardable activity in the list is assigned a predetermined number of reward points, monitoring activities of members of the online community, and comparing the monitored activities to the list of rewardable activities. Based on comparison of the monitored activities to the list of rewardable activities, reward points may be assigned to the members of the online community. The method may also involve tallying the assigned reward points based on one or more predetermined criteria and selecting the one or more members of the virtual government among the members of the online community based on the tallied reward points.

A method may involve advertising the list of rewardable activities to members of the online community. In other embodiments, the members are unaware which activities are encouraged and which one are discouraged. A predetermined number of reward points may vary for different rewardable activities in the list. In certain embodiments, at least one rewardable activity is assigned a negative number of reward points.

A method may involve issuing one or more rewards to the selected one or more members of the virtual government. For example, multiple different rewards are issued and allocated based on a number of the rewards points accumulated by the one or more members of the virtual government. Some examples of rewardable activities include winning an online game, completing a transaction with one or more predetermined businesses, selling a product or a service, purchasing a product or a service, publishing a document, and participating in one or more predetermined real live activities. Published documents may be ranked based on their topics, content, and/or length.

In certain embodiments, comparing the monitored activities to the list of rewardable activities involves reviewing the monitored activities by one or more judges. One or more judges may be current members of the virtual government of the online community. In the same or other embodiments, one or more predetermined criteria used for selecting the one or more members of the virtual government are a predetermined period of time during which the assigned reward points are tallied. In other embodiments, the predetermined criteria are based a total number of rewardable activities performed by the members of the online community. The predetermined criteria include a predetermined point differential.

In certain embodiments, tallying the assigned reward points involves aggregating points for selected members of the online community and assigning these aggregated points to one member of the online community. The method may also involve selecting the members of the online community for participating in the method. In certain embodiments, a virtual government includes multiple divisions and selecting the one or more members of the virtual government involves allocating the one or more members into the multiple divisions based on the tallied reward points. The tallied reward points may include multiple sub-scores identified by multiple subgroups in the list of rewarded activities. In certain embodiments, tallying assigned reward points involves weighing the assigned reward points based on external information about the members of the online community.

Provided is a computer system for selecting one or more members of a virtual government of an online community. The system may include an input module for setting a list of rewardable activities such that each rewardable activity in the list is assigned a predetermined number of reward points, a data collection module for monitoring activities of members of the online community, a processing module, and an output module. The process module may be used for comparing the monitored activities to the list of rewardable activities, for assigning reward points to the members of the online community based on comparison of the monitored activities to the list of rewardable activities, and tallying the assigned reward points based on one or more predetermined criteria. Furthermore, and for selecting the one or more members of the virtual government among the members of the online community based on the tallied reward points. The output module may be used for identifying the one or more members of the virtual government among the members of the online community.

Provided also a computer-readable medium including a set of instructions, which when executed by one or more processors, performs the following. In one operation, a list of rewardable activities may be set and each rewardable activity in the list assigned a predetermined number of reward points. In another operation, activities of members of the online community may be monitored. In yet another operation, monitored activities to the list of rewardable activities may be compared. Furthermore, based on comparison of the monitored activities to the list of rewardable activities, reward points to the members of the online community may be assigned. Operations may also involve tallying the assigned reward points based on one or more predetermined criteria and selecting the one or more members of the virtual government among the members of the online community based on the tallied reward points.

In further exemplary embodiments, modules, subsystems, or devices can be adapted to perform the recited steps. Other features and exemplary embodiments are described below.

### BRIEF DESCRIPTION OF DRAWINGS

Embodiments are illustrated by way of example and not limitation in the figures of the accompanying drawings, in which like references indicate similar elements and in which:

FIG. 1 is a block diagram illustrating an example system in which various embodiments may be implemented.

FIG. 2 is a block diagram showing various modules of the virtual governance engine, in accordance with certain embodiments.

FIG. 3 is a flow chart illustrating a method for selecting members of virtual governments of online communities and establishing honor systems in the online community, in accordance with certain embodiments.

FIG. 4 illustrates an example computer system in which various embodiments may be implemented.

### DETAILED DESCRIPTION

Various systems and methods for selecting members of virtual governments of online communities and establishing honor systems in the online community are described. The virtual government may include a world president, a country president, a governor, a mayor and the like. The virtual government may be selected within the context of a game. Online communities have become very popular in recent years with proliferation of Internet users and new web based technologies and services. An online community may be defined as a virtual community that exists online and whose members enable its existence through taking part in development and operation of these communities. An online community may take the form of an information system where anyone can post content (e.g., open access systems such as bulletin boards) or one where only a restricted number of people can initiate posts (e.g., closed access systems such as weblogs). Online communities have also become a supplemental form of communication and maintaining relationship between people, who may know each other in real life or met for the first time online. Significant sociological shifts have results from proliferation of online communities and amount of information shared within these communities.

Rules and regulations of online communities are often set by their services providers and reflect some particular interests of the service provider. These interests often do not align well with those of the users resulting in low participation, members leaving the community, and the eventual collapse of the community. At the same time, communities often develop some leadership that may be utilized for effective growth and development of the communities. Often, members of online communities begin their life within a community as visitors. After breaking through an initial barrier and learning their surroundings, people become novices and start participating more actively in community life or, more specifically, in community activities. Some of the activities are particularly beneficial, such as sharing new perspectives on topics that community is interested in and performing some administrative duties in the community. Other activities may be less appealing, such as online confrontations with other community members. After contributing for some time, members may become “regulars.” Their names are recognized by other members. They may have a substantial group of followers. If users break through another barrier, then they become leaders. This life cycle can be applied to many virtual communities. However, the leaders are not well defined as, for example, in real-life governments where leaders are elected during formal election processes. Lack of formality may be beneficial in some ways, but often frustrating to many because of unpredictability, possible collapses of various community functions, and other reasons.

The novel methods and systems described herein may be used for selecting members of virtual governments of online communities in a more formalized manner, which may be established by online community members and/or technical service providers. Even though service providers may be involved in some aspects of setting election procedures, similar to setting a first constitution of any government, the remaining parts of the process may be left to the users. These methods and systems may be used for establishing various honor systems in the online community and formally recognize leaders of the community for their contributions. At least, values and missions of the community may be clearly outlined and understood by the community members. Various techniques may be used to stimulate certain activities of online community members and discourage other activities. Overall, a self-control system may be provided within an online community through active participation of its members.

In certain embodiments, activities are associated with reward points and members can accumulate these points based on completing one or more of these activities. One or more members with the most accumulated points are appointed to the government and/or rewarded for their efforts. Some examples of activities include participating in social network forums, conducting product reviews, and purchasing and/or selling products and services. Activities may be categorized to identify category winners as well as overall winners. Furthermore, an online community may create various clusters for conducting such elections and contests.

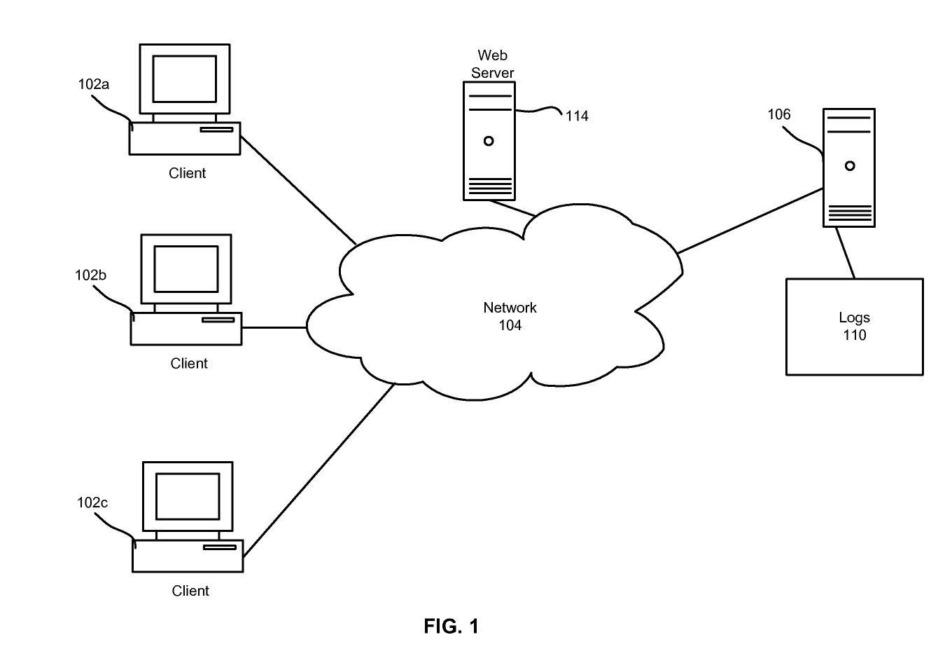

Before describing various methods and associated operations, a brief description of a computer network and a virtual governance engine is provided for better contextual understanding of the methods and operations. Specifically, FIG. 1 illustrates an example network segment for implementing various aspects of methods and operations for selecting members of virtual governments within online communities. As shown, multiple clients 102a, 102b, 102c may access an online community application provided, for example, within virtual governance engine 106 via network 104 and/or access a web service, for example, on web server 114 via a graphical user interface, as will be described in further detail below. The network may take any suitable form, such as a wide area network or Internet and/or one or more local area networks (LAN's). The network 104 may include any suitable number and type of devices, e.g., routers and switches, for forwarding commands, content, and/or web object requests from each client to the online community application and responses back to the clients.

The methods describe herein may also be practiced within a wide variety of network environments (represented by network 104) including, for example, TCP/IP-based networks, telecommunications networks, wireless networks, etc. In addition, the computer program instructions may be stored within any type of computer-readable media. The program may be executed according to a variety of computing models including a client/server model, a peer-to-peer model, on a stand-alone computing device, or according to a distributed computing model in which various functionalities described herein may be effected or employed at different locations.

One way in which an online community may select one or more members of its virtual government is by monitoring activities of its members. Some activities may be associated with reward points and, therefore, may be referred to as rewardable activities. The members may be aware of activities that are rewardable and may know numbers of points associated with each of these activities. When, the system detects that one or more of rewardable activities are performed by a user, a corresponding number of points is assigned to the user. The points are tallied over some time until one or more predetermined criteria are met. At this point, selection of one or more members of the virtual government may be performed. In order to retain various information (e.g., a list of rewardable activities, tallying reward points, etc.), virtual governance engine 106 may have access to one or more logs 110 in which this information is stored. For example, logs 110 may be retained in one or more memories that are coupled to virtual governance engine 106.

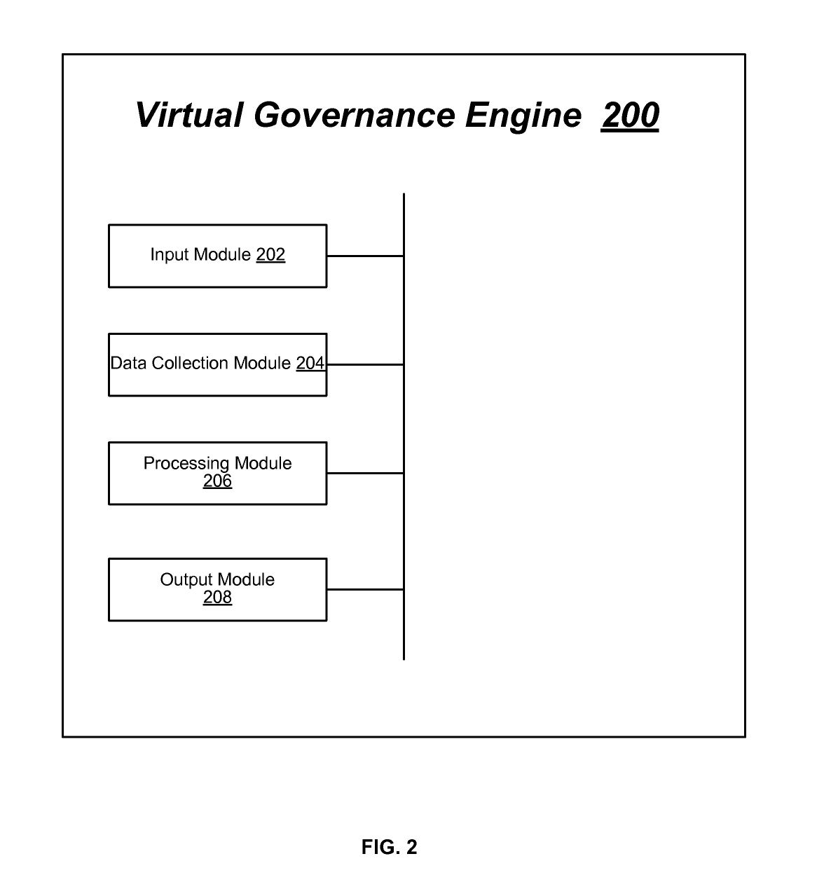

FIG. 2 is a block diagram showing various modules of virtual governance engine 200, in accordance with certain embodiments. Virtual governance engine 200 may include an input module 202 for setting a list of rewardable activities. As stated elsewhere in this document, each rewardable activity in the list is assigned a predetermined number of reward points. For example, members of the online community may provide their suggestions to input module 202, which in turn collects and processes these inputs. Based on these inputs, input module 202 may generate a list of rewardable activities and associated reward points.

In certain embodiments, members of the online community may nominate themselves to certain virtual government positions and provide their nominations to input module 202. The module may then publish the list of the candidates. Other members may assign their reward points to the nominated candidates. Thereby, one member may receive reward points through collective activities of multiple members.

Virtual governance engine 200 may also include a data collection module 204. Data collection module 204 may be used for monitoring activities of members of the online community. These activities may involve rewardable and non-rewardable activities, which are collectively processed later by processing module 206, which is another module of virtual governance engine 200. Specifically, processing module 206 may be used for comparing the monitored activities to the list of rewardable activities. Processing module 206 may be also used for assigning reward points to the members of the online community based on comparison of the monitored activities to the list of rewardable activities. Another function of processing module 206 may include tallying the assigned reward points based on one or more predetermined criteria. Furthermore, processing module 206 may be used for selecting the one or more members of the virtual government among the members of the online community based on the tallied reward points. Virtual governance engine 200 may also include output module 204 for identifying the one or more members of the virtual government among the members of the online community.

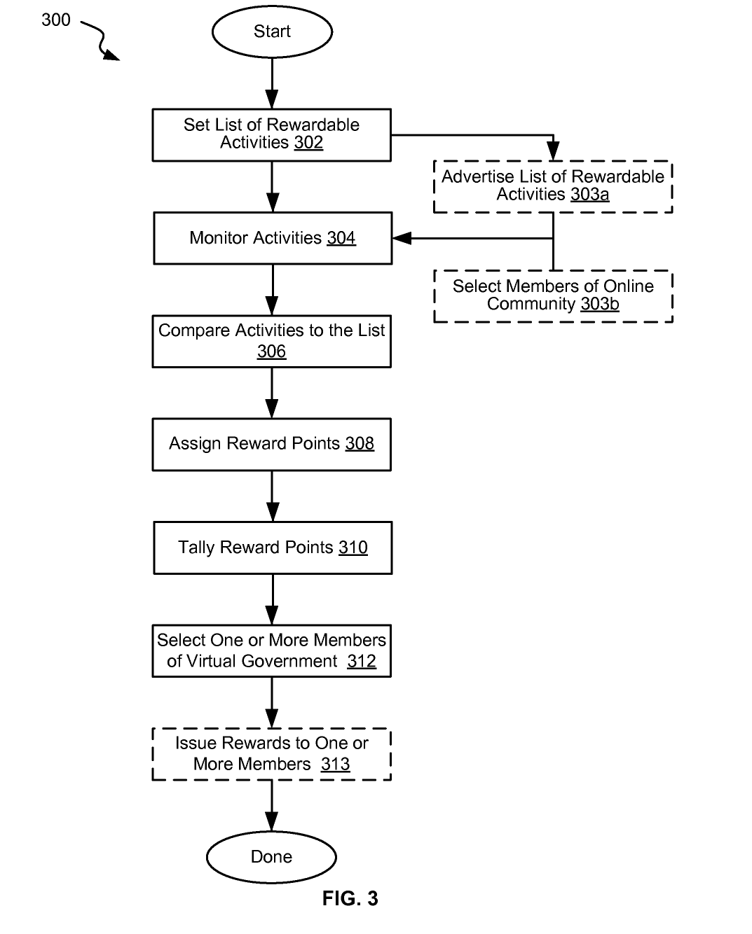

Functions of these modules are further described below with reference to various processes for selecting one or more members of a virtual government of an online community. Specifically, FIG. 3 is a flow chart corresponding to one example of such process 300, in accordance with certain embodiments. Process 300 may start with setting a list of rewardable activities in operation 302. Rewardable activities may be selected to encourage certain behavior and/or activities of members of the online community. By the same token, some rewardable activities may be selected to discourage certain behavior and/or activities of the members. Each rewardable activity in the list may be assigned a predetermined number of points that will be aggregated based on members' participation in one or more of these activities. Different activities may have different number of points associated with the activities. A number of points assigned to a particular activity may reflect how desirable this activity in the online community (e.g., more points for more desirable activities), how difficult this activity is to perform (e.g., more points for more difficult activities), and various other factors. Some activities may be assigned negative points to discourage members from participating in these activities. For example, using inappropriate language in online postings may be fined by subtracting points.

Some examples of activities for presenting in the list include winning an online game or contest, completing a transaction with one or more predetermined businesses, selling a product or a service, purchasing a product or a service, preparing and/or publishing a document, establishing a network of friends, making social and professional contacts in real life and online communities, and participating in one or more predetermined real life activities. For example, an overall “election” may include a number of games designed to test members' intelligence or knowledge of a particular subject or some other skills of the members. A number of businesses may be identified which, for example, sponsor the online community in general or the “election” process in particular. Business transactions may include various promotions of these businesses (e.g., online marketing campaign), product reviews, product purchases and sales, referrals, and many other aspects of the business transactions. The online community may encourage its members to establish and maintain social and/or professional contacts among members of its community. A predetermined number of points may be assigned for establishing a new contact, exchanging information with existing contacts, and other social and/or professional activities with other members of the online community. Some additional examples include promotion of a product or a service, activities directed to a mutual understanding and friendship within a social networking website, participating in online games, participation in local (real live) businesses and local social events, participating in various international events, reviewing a business, and commenting on a news.

Activities presented in the list may be allocated into multiple categorizes. These categories may be selected based on specific requirements of certain positions in the virtual government. For example, one position may require good writing skills, while another may require better business acumen or knowledge of a particular language. In addition to the total number of points, members may have a subset of points in each of these categories, which may qualify them for various positions.

In certain embodiments, process 300 may involve advertising the list of rewardable activities as reflected by an optional operation 303a in FIG. 3. The advertising may be used to draw attention to the overall process and to inform members of the online community of encouraged and discourages activities as well as of the rewards associated with these activities. This operation may provide various additional rules of the overall “election,” such as timing, rewards, and other aspects.

In certain embodiments, the list is not published and may be completely or at least partially hidden. This approach may stimulate members of the online community to participate in more activities and not only the one provided in the list. For example, some general guideless (e.g., categories of the activities) may be public. This partial disclosure of information may provide general ideas to the members and encourage them to participate.

In the same or other embodiments, process 300 may involve selecting members of the online community for participating in the “election” as reflected by an optional operation 303b in FIG. 3. In these embodiments, a subset of all members may participate. This subset may be selected based on certain predetermined criteria, such as age, gender, geographic location, language, interest, and so forth and may disqualify certain other members of the online community. For example, a local municipality may restrict its election to online users who live within the boundaries of these municipalities.

In one example, only activities of selected members are monitored and tallied and other members may not participate in the “election” at all. In other embodiments, members that were not selected may still participate in activities and accumulate points, but these points are assigned to one or more of the selected “candidates.” Thus, unselected members may vote for the selected ones. Various schemes can be used for allocating points from one member to another. For example, one selected member may simply aggregate points from one or more unselected members. An unselected member may allocate points between multiple selected members based on some ratios. Furthermore, point allocations between members may be conditional on various events.

Process 300 may proceed with monitoring activities of members in operation 304. For example, a data collection module may collect and monitor information corresponding to members' activities. As mentioned above, activities of all members may be monitored. In other embodiments, activities of selected members may be monitored. Process 300 may also include operation 306 involving comparison of the monitored activities to the list of rewardable activities. In certain embodiments, operations 304 and 306 can be combined into a single operation and performed by the same module.

Process 300 may proceed with assigning reward points to the members of the online community based on comparison of the monitored activities to the list of rewardable activities in operation 308. Specifically, if an activity performed by a member matches one or more activities in the list, then this member or his/her proxy is assigned a corresponding number of points. While point allocation among different activities may be the same for all members, each member may have a different coefficient by which this point allocation is multiplied. This coefficient scheme allows to stimulate participation of certain members and to discourage participation of other members. Furthermore, such coefficients may depend on previous activities of members. For example, a member who wrote a product review after purchasing the product may receive more points that another member who wrote a product review without purchasing any products.

In certain embodiments, members are notified right away about additional points added to their balance. Members may also view balances of other members. Overall, an online community may have an “election dashboard” for monitoring the progress of such elections. In other embodiments, results of other members are hidden until the very end. Furthermore, results of individual members may be hidden to encourage continuous participation in various activities.

Process 300 may proceed with tallying the assigned reward points based on predetermined criteria in operation 310. This operation may involve simple aggregation of all points, for example, during a predetermined period. Other criteria may be used as well. For example, tallying may involve determining one or more members who first aggregated a predetermined number of points (e.g., overall points, points in specific categories). In the same or other embodiments, tallying involves determining point differentials among different members and so forth.

Process 300 may also involve selecting the one or more members of the virtual government among the members of the online community based on the tallied reward points in operation 312. These selected members may receive various rewards associated with this process in optional operation 313. For example, a member with the most points may be assigned a title of president of the online community as well as certain roles and responsibilities and rewards. There may be multiple members in the virtual government selected by the most overall points or points collected in specific categories.

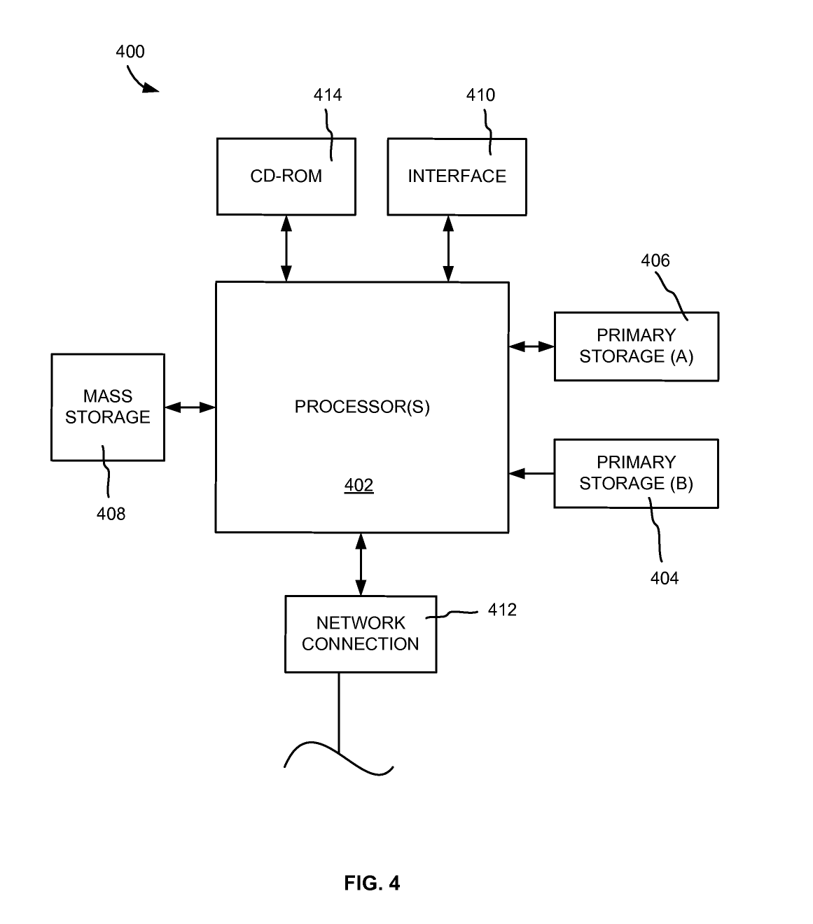

FIG. 4 illustrates a computer system that may be configured or designed for performing various operations describe above, in accordance with certain embodiments. The computer system 400 includes any number of processors 402 (also referred to as central processing units, or CPUs) that are coupled to storage devices including primary storage 406 (typically a random access memory, or RAM), primary storage 404 (typically a read only memory, or ROM). CPU 402 may be of various types including microcontrollers and microprocessors such as programmable devices (e.g., CPLDs and FPGAs) and unprogrammable devices such as gate array ASICs or general purpose microprocessors. Primary storage 404 may act to transfer data and instructions uni-directionally to the CPU and primary storage 406 is used typically to transfer data and instructions in a bi-directional manner. Both of these primary storage devices may include any suitable computer-readable media such as those described above. A mass storage device 408 is also coupled bi-directionally to CPU 402 and provides additional data storage capacity and may include any of the computer-readable media described above. Mass storage device 408 may be used to store programs, data and the like and is typically a secondary storage medium such as a hard disk. It will be appreciated that the information retained within the mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications network using an external connection as shown generally at 412. With such a connection, it is contemplated that the CPU might receive information from the network, or might output information to the network in the course of performing the operations described herein.

The example embodiments described herein may be implemented in an operating environment including software installed on a computer, in hardware, or in a combination of software and hardware.

Thus, various systems and methods for selecting one or more members of virtual governments of online communities have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A computer-implemented method for selecting one or more members of a virtual government of an online community, the method comprising:
setting a list of rewardable activities, each rewardable activity in the list is assigned a predetermined number of reward points;
monitoring activities of members of the online community,
comparing the monitored activities to the list of rewardable activities;
based on the comparison of the monitored activities to the list of rewardable activities, assigning reward points to the members of the online community;
tallying the assigned reward points based on one or more predetermined criteria; and
selecting the one or more members of the virtual government among the members of the online community based on the tallied reward points.

2. The method of claim 1, further comprising advertising the list of rewardable activities to members of the online community.

3. The method of claim 1, wherein the predetermined number of reward points varies for different rewardable activities in the list.

4. The method of claim 1, wherein at least one rewardable activity is assigned a negative number of reward points.

5. The method of claim 1, further comprising issuing one or more rewards to the selected one or more members of the virtual government.

6. The method of claim 5, wherein multiple different rewards are issued and allocated based on a number the rewards points accumulated by the one or more members of the virtual government.

7. The method of claim 1, the list of rewardable activities comprises one or more activities selected from the group consisting of: winning an online game, completing a transaction with one or more predetermined businesses, selling a product or a service, purchasing a product or a service, paying for a product or service, publishing a document, uploading a video or an image, writing a review, making recommendations for a product or a service to others, making bulletin board called multimedia walls, and participating in one or more of predetermined real live activities.

8. The method of claim 1, wherein the one or more members of a virtual government of an online community selected via an online voting system and include a world president, a country president, governors of seven continents, and a mayor.

9. The method of claim 1, wherein comparing the monitored activities to the list of rewardable activities comprises reviewing the monitored activities by one or more judges.

10. The method of claim 1, wherein the virtual government is selected within the context of a game.

11. The method of claim 1, wherein the one more predetermined criteria comprise predetermined period of time during which the assigned reward points are tallied.

12. The method of claim 1, wherein the one or more predetermined criteria comprise a total number of rewardable activities performed by the members of the online community.

13. The method of claim 1, wherein the one or more predetermined criteria comprise a predetermined points differential.

14. The method of claim 1, wherein tallying the assigned reward points comprising aggregating points for selected members of the online community and assigning these aggregated points to one member of the online community.

15. The method of claim 1, further comprising selecting the members of the online community for participating in the method.

16. The method of claim 1, wherein the virtual government comprises multiple divisions and wherein selecting the one or more members of the virtual government comprises allocating the one or more members into the multiple divisions based on the tallied reward points.

17. The method of claim 16, wherein the tallied reward points comprise multiple sub-scores identified by multiple subgroups in the list of rewarded activities.

18. The method of claim 1, wherein tallying the assigned reward points comprises weighing the assigned reward points based on external information about the members of the online community.

19. The method of claim 1, wherein the virtual government may include a world president, a country president, governors of seven continents, and a mayor

20. A computer system for selecting one or more members of a virtual government of an online community, the system comprising:
an input module for setting a list of rewardable activities, each rewardable activity in the list is assigned a predetermined number of reward points;
a data collection module for monitoring activities of members of the online community;
a processing module for comparing the monitored activities to the list of rewardable activities, for assigning reward points to the members of the online community based on comparison of the monitored activities to the list of rewardable activities, tallying the assigned reward points based on one or more predetermined criteria, and for selecting the one or more members of the virtual government among the members of the online community based on the tallied reward points; and
an output module for identifying the one or more members of the virtual government among the members of the online community.

21. A computer-readable medium comprising instructions, which when executed by one or more processors, perform the following operations:
set a list of rewardable activities, each rewardable activity in the list is assigned a predetermined number of reward points;
monitor activities of members of the online community, compare the monitored activities to the list of rewardable activities;
based on comparison of the monitored activities to the list of rewardable activities, assign reward points to the members of the online community;
tally the assigned reward points based on a predetermined criteria; and
select the one or more members of the virtual government among the members of the online community based on the tallied reward points.
